(19) United States
(12) Patent Application Publication
(10) Pub. No.: US 2020/0396292 A1
(43) Pub. Date: Dec. 17, 2020

(54) IoT DEVICE CONTROL METHOD, RECORDING MEDIUM HAVING PROGRAM RECORDED THEREON, AND IoT NETWORK INFRASTRUCTURE SYSTEM

(71) Applicant: NEC Corporation, Minato-ku, Tokyo (JP)

(72) Inventor: Jun ONO, Tokyo (JP)

(73) Assignee: NEC Corporation, Minato-ku, Tokyo (JP)

(21) Appl. No.: 16/957,254

(22) PCT Filed: Dec. 19, 2018
(86) PCT No.: PCT/JP2018/046856

§ 371 Date: Jun. 23, 2020

(30) Foreign Application Priority Data
Dec. 28, 2017 (JP) 2017-254619

(51) Int. Cl. H04L 29/08; G16Y 40/30

(52) U.S. Cl. CPC H04L 67/12; G16Y 40/30

(57) ABSTRACT

To increase the probability of acquisition of desired data from an IoT device during emergency, this IoT device control method comprises: receiving external information; on the basis of the received external information, selecting an IoT device from a first IoT device that transmits data during normal time and a second IoT device different from the first IoT device; and instructing the selected IoT device to transmit data.

### TECHNICAL FIELD

The present invention relates to an IoT device control method, a program, and an IoT network infrastructure system.

### BACKGROUND ART

There is a disaster prevention system that acquires an image from a camera for disaster prevention.

For example, a disaster prevention system described in PTL 1 includes a fixed camera device, a mobile camera device, and disaster prevention center system. The disaster prevention center system receives video information transmitted from the fixed camera device and the mobile camera device. The disaster prevention center system displays and accumulates the received video information.

### CITATION LIST

### Patent Literature

[PTL 1] Japanese Unexamined Patent Application Publication No. 2012-178662

### SUMMARY OF INVENTION

### Technical Problem

There is a problem such as limitation of cost and an installation place, for installation and operation of an internet of things (IoT) device such as a camera, a temperature sensor, a rainfall sensor, and a GPS sensor. Thus, it is considered that the installation number of IoT devices is limited. Therefore, there is a possibility that it is not possible to acquire desired data from an IoT device during time of emergency such as time of disaster occurrence, time of accident occurrence, or time of congestion occurrence.

An object of the present invention is to provide an IoT device control method, a program, and an IoT network infrastructure system that can solve the problem described above.

### Solution to Problem

According to a first aspect of the present invention, an IoT device control method includes: receiving external information; selecting, based on the received external information, an IoT device from a first IoT device that transmits data during normal time and a second IoT device different from the first IoT device; and instructing the selected IoT device to transmit data.

According to a second aspect of the present invention, a program causes a computer to execute: processing of receiving external information; processing of selecting, based on the received external information, an IoT device from a first IoT device that transmits data during normal time and a second IoT device different from the first IoT device; and processing of instructing the selected IoT device to transmit data.

According to a third aspect of the present invention, an IoT network infrastructure system that controls an IoT device includes: an external information reception unit that receives external information; a selection logic calculation unit that selects, based on the received external information, an IoT device from a first IoT device that transmits data during normal time and a second IoT device different from the first IoT device; and a device control unit that instructs the selected IoT device to transmit data.

### Advantageous Effects of Invention

The present invention raises a possibility of acquiring desired data from an IoT device during time of emergency such as time of disaster occurrence, time of accident occurrence, or time of congestion occurrence.

### BRIEF DESCRIPTION OF DRAWINGS

FIG. 1 is a schematic block diagram illustrating a functional configuration of an internet of things (IoT) network system according to an example embodiment.

FIG. 2 is a diagram illustrating an example of a hierarchical structure in the IoT network system according to the example embodiment.

FIG. 3 is a diagram illustrating an example of an operation of an IoT network infrastructure system during normal time in the example embodiment.

FIG. 4 is a diagram illustrating an example of a procedure of processing performed by the IoT network infrastructure system, based on external information, during occurrence of a disaster in the example embodiment.

FIG. 5 is a diagram illustrating an example of processing performed by the IoT network infrastructure system, based on an instruction of a user, during occurrence of a disaster in the example embodiment.

FIG. 6 is a diagram illustrating an example of a processing procedure in which the IoT network infrastructure system according to the example embodiment evaluates an image data from an IoT device.

FIG. 7 is a diagram illustrating an example of a processing procedure in which the IoT network infrastructure system according to the example embodiment causes a selected IoT device to transmit image data.

FIG. 8 is a diagram illustrating an example of a processing procedure of the IoT network infrastructure system when a plurality of terminal devices exist, and a data request to or control of the same IoT device from the plurality of terminal devices is needed, in the example embodiment.

FIG. 9 is a diagram illustrating an example of a minimum configuration of the IoT network infrastructure system according to the example embodiment.

FIG. 10 is a diagram illustrating an example of a minimum configuration of an IoT network infrastructure system according to the example embodiment.

### EXAMPLE EMBODIMENT

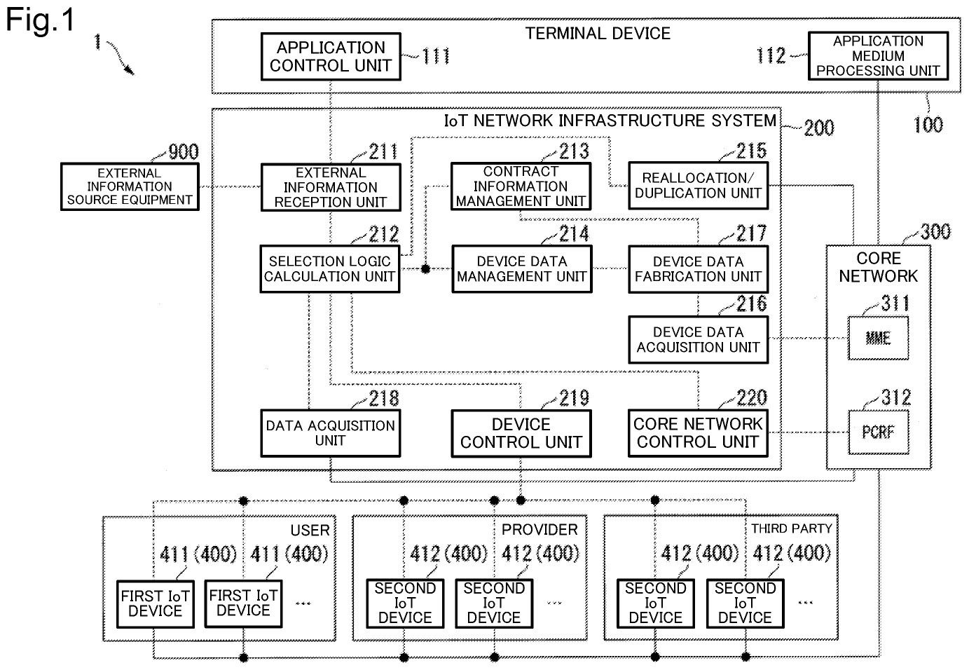

A preferred example embodiment of the present invention is described below, but the following example embodiment does not limit the invention according to claims. Not all combinations of features described in the example embodiment are necessary for a solving means of the invention. FIG. 1 is a schematic block diagram illustrating a functional configuration of an internet of things (IoT) network system according to the example embodiment. In the configuration illustrated in FIG. 1, an IoT network system 1 includes a terminal device 100, an IoT network infrastructure system 200 that executes an IoT device control method, a first IoT device 411, and a second IoT device 412. The terminal device 100 includes an application control unit 111 and an application medium processing unit 112. The IoT network infrastructure system 200 includes an external information reception unit 211, a selection logic calculation unit 212, a contract information management unit 213, a device data management unit 214. The IoT network infrastructure system 200 also includes a reallocation/duplication unit 215, a device data acquisition unit 216, a device data fabrication unit 217, a data acquisition unit 218, a device control unit 219, and a core network control unit 220.

The terminal device 100, the IoT network infrastructure system 200, the first IoT device 411, and the second IoT device 412 communicate and connect via a core network 300. The core network 300 includes an MME 311 and a PCRF 312. The IoT network infrastructure system 200 communicates with and connects to external information source equipment 900.

Hereinafter, the first IoT device 411 and the second IoT device 412 are generically named an IoT device 400. A full line represents a path of data transmitted by the IoT device 400, and a broken line represents a path of another piece of data or signal. The IoT device 400 is a generic name of a device having a function of connecting to a network. For example, the IoT device 400 may be configured by including a camera, and capture a moving image or a still image. Alternatively, the IoT device 400 may be configured by including various sensors that measure temperature, humidity, rainfall, a water level of a river, gas concentration, vibration, a GPS, and the like. The IoT device 400 may be configured as a communication terminal such as a mobile phone, a vehicle, or a drone having any of the functions. Various data acquired by the IoT device 400 are conceivable depending on a kind of IoT device 400, such as a moving image, a still image, temperature, humidity, rainfall, a water level of a river, gas concentration, frequency, and position information. The first IoT device 411 may acquire data at a predetermined timing (e.g., on the hour, only in the daytime, only in the daytime on a workday, or the like), based on a control signal transmitted by the IoT network infrastructure system 200, and transmit data to the terminal device 100, for example.

The IoT network infrastructure system 200 is a system that controls the IoT device 400. The IoT network infrastructure system 200 instructs the first IoT device 411 to transmit data during normal time. The first IoT device 411 may transmit data during normal time in a predetermined period, for example, on the hour, only in the daytime, only at night on a workday, or the like. The IoT network infrastructure system 200 may instruct the first IoT device 411 to transmit data, for example, at each predetermined timing. The IoT network infrastructure system 200 may instruct the first IoT device 411 to transmit data, for example, only during a communication with the first IoT device 411 for initial setting or the like. Herein, normal time refers to a time when an event such as a disaster, an accident, or congestion does not occur. In this case, the terminal device 100 uses only output data from the first IoT device 411. On the other hand, an emergent state refers to, for example, a state where an event such as a disaster, an accident, or congestion occurs.

On the other hand, when receiving external information, the IoT network infrastructure system 200 selects, based on the external information, an IoT device from the first IoT device 411 and the second IoT device 412, and instructs the selected IoT device to transmit data. The external information includes information indicating a place in an emergent state, such as a place where a disaster occurs, a place where an incident or an accident occurs, or a place where congestion occurs. The IoT network infrastructure system 200 may select, based on the information being included in the external information and indicating the place in an emergent state, an IoT device being present at or in the vicinity of the place in an emergent state, from the first IoT device 411 and the second IoT device 412. The external information refers to information received from an external device other than the IoT network infrastructure system 200.

The external device may be, for example, the external information source equipment 900 or the terminal device 100. When the external device is the external information source equipment 900, the external information may be information such as occurrence of an earthquake with a seismic intensity of 6 in a prefecture A. In addition, the external information may be information such as occurrence of suicidal terrorism at a point B, occurrence of congestion in a section D of a road C, or a heavy rain and flood warning in a western part of a prefecture E. In this instance, information such as the prefecture A, the point B, the section D of the road C, or the western part of the prefecture E serves as information indicating a place in an emergent state. When the external device is the terminal device 100, the external information may be information based on data transmitted by the first IoT device 411 during normal time. For example, the external information may be information such as information indicating that the first IoT device 411 installed on a tenth floor of a building F detects a fire, or information indicating that the first IoT device 411 installed on a downstream of a river G detects a water level being equal to or more than a threshold value. In this instance, information such as the tenth floor of the building F or the downstream of the river G serves as information indicating a place in an emergent state.

The IoT network infrastructure system 200 is configured by using a computer such as a workstation or a personal computer (PC). Each of the function units (211 to 220) of the IoT network infrastructure system 200 illustrated in FIG. 1 is achieved by reading and then executing, by a central processing unit (CPU) included in the IoT network infrastructure system 200, a program from a storage device included in the IoT network infrastructure system 200. The IoT network infrastructure system 200 may comprise a combination of a plurality of devices in such a way as comprising a plurality of workstations.

A provider referred to herein is a provider that provides a data providing service by using the IoT network system 1. A user referred to herein is a user of the data providing service using the IoT network system 1. For example, the terminal device 100 may be a terminal device for disaster prevention installed in a disaster prevention center of a local government or the like, and a user may be a person in charge working for the disaster prevention center.

A third party referred to herein is a party other than the user himself/herself or the provider. A third party referred to herein may be another user, or may be a party that only provides data without receiving the data providing service using the IoT network system 1. For exchange of data in the data providing service using the IoT network system 1, the user and the third party each make a contract with the provider in advance.

The terminal device 100 functions as a terminal device of the IoT network system 1 by executing an application program for the data providing service using the IoT network system 1. The terminal device 100 comprises, for example, a computer such as a personal computer, a tablet terminal device, or a smartphone. The number of the terminal devices 100 included in the IoT network system 1 is not limited to one illustrated in FIG. 1, and may be plural. There may be a plurality of users who use the data providing service using the IoT network system 1. Hereinafter, the application program for the data providing service using the IoT network system 1 is simply referred to as an application.

The application control unit 111 controls each unit of the terminal device 100 by executing the application. Particularly, the application control unit 111 transmits a data request to the IoT network infrastructure system 200 in accordance with a user operation requesting data. The application control unit 111 performs transmission and reception of a signal of a data request or the like by using a communication function included in the terminal device 100. A method by which the application control unit 111 transmits a data request is not limited to a specific method. Particularly, the application control unit 111 may transmit a data request by using the core network 300, or a data request may be transmitted by using a signal path other than the core network 300. The application medium processing unit 112 receives and processes data transmitted by the IoT device 400 via the core network 300. For example, the IoT device 400 transmits image data, and the application medium processing unit 112 displays the received image data on a display screen included in the terminal device 100.

The IoT device 400 acquires data on a scene such as a monitoring target point, and transmits the acquired data to the terminal device 100. Hereinafter, data acquired by the IoT device 400 are referred to as scene data. The IoT device 400 transmits scene data to the indicated terminal device 100, based on control information transmitted by the IoT network infrastructure system 200. Scene data being acquirable by the terminal device 100 (scene data being acquirable by the user) are predetermined by a contract between the user and the provider. For example, in the configuration in FIG. 1, the terminal device 100 is always able to acquire scene data of the first IoT device 411 that is the IoT device 400 being under management of the user of the terminal device 100.

On the other hand, the terminal device 100 is able to acquire scene data from only some of the second IoT devices 412 predetermined by a contract among the second IoT devices 412 being under management of a party different from the user of the terminal device 100. The contract may be permission for the second IoT device 412 to provide scene data to a party other than a manager (i.e., the terminal device 100) of the local device (the second IoT device 412) during time of emergency such as time of disaster occurrence, time of accident occurrence, or time of congestion occurrence. The contract may include a priority degree of a communication in which the second IoT device 412 provides scene data to the terminal device 100. Alternatively, it may be determined that the terminal device 100 is able to acquire scene data of all the second IoT devices 412 during time of emergency. When scene data of the second IoT device are anonymized, it may be determined that the terminal device 100 is able to acquire scene data of the second IoT device 412 during normal time as well.

The external information source equipment 900 provides external information to the IoT network infrastructure system 200. For example, the external information source equipment 900 may be a disaster prevention information providing system, and provide external information such as disaster prevention information or disaster information to the IoT network infrastructure system 200. The external information source equipment 900 may be a traffic information system, and provide road traffic information such as congestion information to the IoT network infrastructure system 200 as external information. The external information includes information indicating a place in an emergent state, such as a place where a disaster occurs, a place where an accident occurs, or a place where congestion occurs. The IoT network infrastructure system 200 selects, based on the external information, the IoT device 400 that transmits scene data to the terminal device 100 during time of emergency. The IoT network infrastructure system 200 may select, based on information being included in the external information and indicating a place in an emergent state, an IoT device being present at or in the vicinity of the place in an emergent state, from the first IoT device 411 and the second IoT device 412.

The core network 300 is a network forming a basis of a communication network provided by a communication carrier. The core network 300 mediates transmission of scene data from the IoT device 400 to the terminal device 100 in particular. Herein, a case where the core network 300 is a core network of a mobile phone network is described as an example. The core network 300 may be a communication network being able to control a band of each communication and being able to control a priority degree of each communication, and is not limited to a specific kind of network. For example, the core network 300 may be a communication network for a fixed phone. Alternatively, the core network 300 may comprises combining a plurality of communication networks.

As described above, a case where the core network 300 is a core network of a mobile phone network is described herein as an example. The core network 300 includes each of the following units.
A policy and charging rules function (PCRF): a logic node that performs control for quality of service (QoS) and accounting of user data transfer.
A packet data network gateway (P-GW): a point of connection to a packet data network (PDN, an external network), and a gateway that performs allocation of an IP address, packet transfer to an S-GW, and the like.
A serving gateway (S-GW): a service area packet gateway that accommodates a mobile access system.
A mobility management entity (MME): a logic node that accommodates an eNodeB and performs mobility control.
A serving general packet radio service (GPRS) support node (SGSN): a logic node having a packet communication function.
A home subscriber server (HSS): a subscriber information database being in a mobile communication network and managing authentication information and service area information.
An evolved Node B (eNodeB, eNB): a wireless base station compliant with a predetermined wireless communication method.

Among these, FIG. 1 illustrates the MME 311 and the PCRF 312. The MME 311 provides information relating to the IoT device 400 to the IoT network infrastructure system 200. Particularly, the MME 311 provides information relating to communication status of the IoT device 400 and position information of the IoT device 400 to the IoT network infrastructure system 200. The PCRF 312 performs band control and priority control of communication of the IoT device 400.

The IoT network infrastructure system 200 executes a control method of an IoT device. The IoT network infrastructure system 200 instructs the IoT device 400 to transmit scene data, by transmitting control information to the IoT device 400. Particularly, when receiving external information, the IoT network infrastructure system 200 selects an IoT device from the first IoT device 411 and the second IoT device 412, and instructs the selected IoT device to transmit scene data. The IoT network infrastructure system 200 determines a priority degree of the selected IoT device, in accordance with a condition determined by a contract. The IoT network infrastructure system 200 transmits a control signal to the core network 300, based on the determined priority degree. The core network 300 performs priority control relating to a communication of the IoT device, based on the received control signal. The priority control may be control of expanding a communication band of a specific IoT device, or may be control of elevating a priority degree of communication, for example.

The external information reception unit 211 is a function unit for the IoT network infrastructure system 200 to cooperate with the terminal device 100 and the external information source equipment 900. As described above, the external information source equipment 900 may be a disaster prevention information providing system of the Meteorological Agency or a weather company, and the external information reception unit 211 may receive external information such as disaster information from the disaster prevention information providing system. When the user performs, on the terminal device 100, an input operation of an area being desired to be checked, the external information reception unit 211 may receive, from the terminal device 100, a data request indicating the designated area, as external information. The external information reception unit 211 may receive, from the terminal device 100, information based on data transmitted by the first IoT device 411 during normal time, as external information. The information based on data transmitted by the first IoT device 411 during normal time may be, for example, information indicating that data acquired by the first IoT device 411 exceed a threshold value. The information based on data transmitted by the first IoT device 411 during normal time may be, for example, information indicating that the first IoT device 411 detects a fire, or information indicating that a river near a place where the first IoT device 411 is installed has a risk of flooding. Information received by the external information reception unit 211 from the external information source equipment 900, and information received by the external information reception unit 211 from the terminal device 100 each apply to an example of external information.

The selection logic calculation unit 212 selects, based on the external information received by the external information reception unit 211, an IoT device to be instructed to transmit scene data, from the first IoT device 411 and the second IoT device 412. The selection logic calculation unit 212 determines a logic applied to selection of the IoT device 400, by cooperating with the external information reception unit 211. As described above, external information received by the external information reception unit 211 includes information indicating a place in an emergent state. The selection logic calculation unit 212 selects, from the first IoT device 411 and the second IoT device 412, an IoT device installed at or in the vicinity of the place in an emergent state.

Alternatively, the selection logic calculation unit 212 may select, in addition to or instead of the IoT device 400 installed at or in the vicinity of the place in an emergent state, the IoT device 400 determined as an IoT device associated with the place in an emergent state. For example, when a flood occurs in an area surrounding a certain river, the selection logic calculation unit 212 may select the IoT device 400 installed in the upstream of the river, in addition to or instead of the IoT device 400 at a place where the flood occurs.

The selection logic calculation unit 212 acquires contract information from the contract information management unit 213, and acquires use status information of the IoT device 400 from the device data management unit 214. The selection logic calculation unit 212 inputs, to the determined logic, the contract information and the use status information of the IoT device 400, and then determines the IoT device 400 that is caused to transmit scene data to the terminal device 100.

The contract information management unit 213 manages contract information indicating a contract between the user and the provider. The contract information indicates, for example, a range of the second IoT device 412 that the user is able to utilize (i.e., whether the second IoT device 412 is usable), a utilization condition (whether to anonymize scene data, what kind of emergent state to be applied to, and the like), and an accounting method. The device data acquisition unit 216 acquires device data from the core network 300. The device data referred to herein is information relating to each of the IoT devices 400. The device data includes information relating to communication status of each of the IoT devices 400, and position information of the IoT device 400.

The device data fabrication unit 217 fabricates the device data acquired by the device data acquisition unit 216 from the core network 300 in such a way that the device data are easy to handle. For example, when information from the core network 300 includes information with which an individual is identifiable, the device data fabrication unit 217 performs anonymization of the information, in such a way as to delete information with which an individual is identifiable. For example, a fabrication method of the device data may be determined by a contract between a scene data provider and a provider. In this case, the device data fabrication unit 217 fabricates the device data, based on the contract.

The device data management unit 214 stores and manages the device data acquired by the device data acquisition unit 216 and fabricated by the device data fabrication unit 217 as needed. For example, the device data management unit 214 stores and manages the following information as device data for each of the IoT devices 400.
An equipment ID of the IoT device 400 (identification information of the IoT device 400).
A band allocated to a communication of the IoT device 400.
A priority degree of a communication of the IoT device 400.
An owner name of the IoT device 400 (identification information of an owner of the IoT device 400).
Use status of the IoT device 400 (e.g., “in use” or “not used”).

The reallocation/duplication unit 215 performs processing when the selection logic calculation unit 212 selects one IoT device 400 as the IoT device 400 being a scene data transmission source with regard to the plurality of terminal devices 100. When the plurality of terminal devices 100 are able to share scene data of the IoT device 400, the reallocation/duplication unit 215 duplicates the scene data from the IoT device 400, and then transmits duplicated scene data to each of the plurality of terminal devices 100.

On the other hand, when it is not possible for the plurality of terminal devices 100 to share the scene data of the IoT device 400, the reallocation/duplication unit 215 alters allocation (performs reallocation) of the IoT device 400 to the terminal device 100. The IoT device 400 allocated to the terminal device 100 referred to herein is the IoT device 400 controlled in such a way as to transmit scene data to the terminal device 100.

When altering allocation of the IoT device 400 to the terminal device 100, the reallocation/duplication unit 215 maintains allocation of the IoT device 400 with regard to the terminal device 100 having the highest priority order, based on, for example, a priority order determined according to a contract or a kind of application. For another one of the terminal devices 100, the reallocation/duplication unit 215 causes the selection logic calculation unit 212 to select the next best IoT device 400, and allocates the selected IoT device 400 to the terminal device 100.

The data acquisition unit 218 acquires scene data from the IoT device 400. The device control unit 219 controls the IoT device 400. When the scene data acquired by the data acquisition unit 218 has a disadvantage, the device control unit 219 alters a condition for acquiring data, by controlling the IoT device 400. For example, a case where the IoT device 400 is a camera that acquires image data is described. When a state of an image is not good in image data acquired by the data acquisition unit 218, the device control unit 219 transmits, to the IoT device 400, such a control signal as to change a direction (direction of capturing) of the IoT device 400 or alter a zoom. The core network control unit 220 transmits a control signal to the core network 300. Particularly, the core network control unit 220 instructs the PCRF 312 to control a communication band and a priority degree of each of the IoT devices 400.

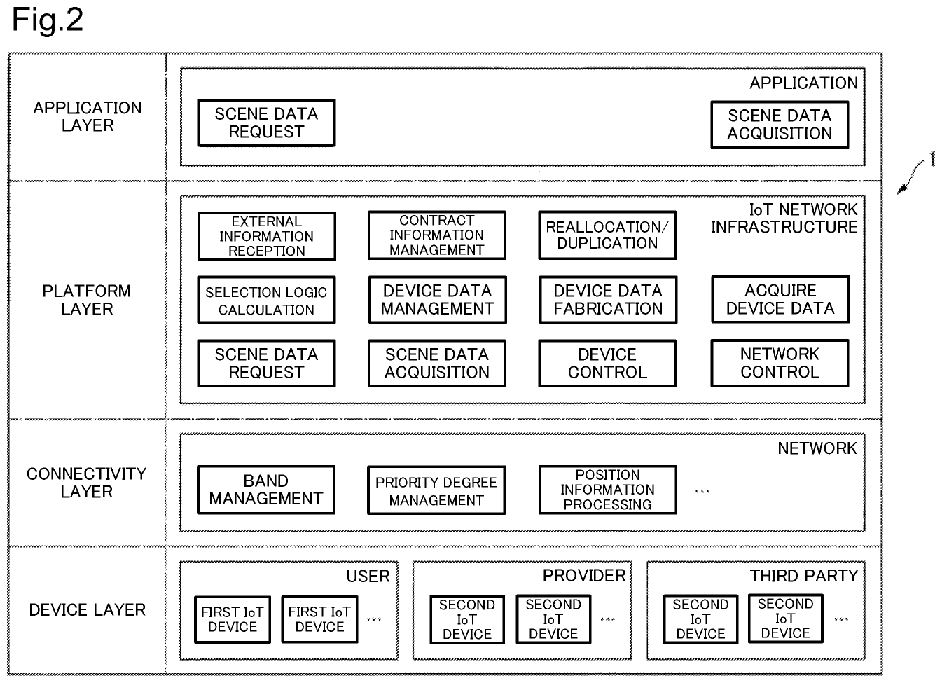

FIG. 2 is a diagram illustrating an example of a hierarchical structure in the IoT network system 1. In FIG. 2, functions or devices constituting the IoT network system 1 are classified into an application layer, a platform layer, a connectivity layer, and a device layer. An application function executed by the terminal device 100 is classified into the application layer. The application function includes a request for scene data by the application control unit 111, and acquisition of scene data by the application medium processing unit 112.

An IoT network infrastructure function by the IoT network infrastructure system 200 is classified into the platform layer. The IoT network infrastructure function includes each of the following functions.
Reception of external information by the external information reception unit 211.
Selection logic calculation by the selection logic calculation unit 212 (calculation of a logic for determining the IoT device 400 that causes the terminal device 100 to transmit scene data).
Management of contract information by the contract information management unit 213.
Management of device data by the device data management unit 214.
Reallocation of the IoT device 400 to the terminal device 100 by the reallocation/duplication unit 215, and duplication of scene data of the IoT device 400.
Acquisition of device data by the device data acquisition unit 216.
Fabrication of device data by the device data fabrication unit 217.
Request for scene data to the IoT device 400 by the data acquisition unit 218, and acquisition of the requested scene data.
Control of the IoT device 400 by the device control unit 219.
Control of the core network 300 by the core network control unit 220.

A communication network provided by the core network 300 is classified into the connectivity layer. Band management, priority degree management, and position information processing are included as management or processing in the communication network. In the band management, a band allocated to each communication in the core network 300 is managed. In the priority degree management, a priority degree of each communication in the core network 300 is managed. In the position information processing, position information of the IoT device 400 is acquired. Particularly, position information of a movably configured IoT device 400 such as an in-vehicle IoT device is acquired in the position information processing.

The IoT device 400 is classified into the device layer. As described above, the IoT device 400 includes the first IoT device 411 being under management of a user, and the second IoT device 412 being under management of a party other than the user such as a provider or a third party.

As in FIG. 2, in the IoT network system 1, the application layer and the platform layer are separated. The IoT network system 1 operates in such a way that an application side (the terminal device 100 side) can accomplish an object (a desire to view an image of a specific area, or the like) without being aware of status of the IoT device 400 (power off, battery depletion, a position of installation, or the like). To this end, an IoT network infrastructure side (the IoT network infrastructure system 200 side) absorbs a complicated selection logic calculation. For example, when an application is a “monitoring application” (an application for monitoring a specific place such as a place where a disaster occurs), the user selects, from a GUI, an area of interest being desired to be monitored (e.g., performs an encircling touch operation). Thus, an image can be acquired from the IoT device 400 in the area of interest.

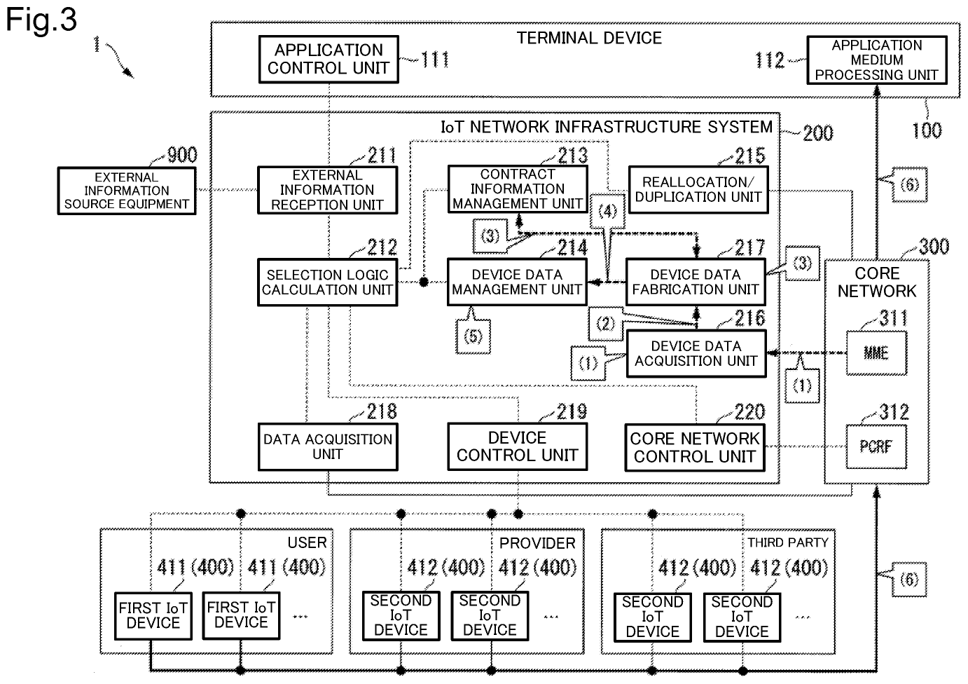

Next, an operation of the IoT network infrastructure system 200 is described with reference to FIGS. 3 to 8. A case where the IoT device 400 is configured by including a camera, and the IoT network infrastructure system 200 provides an image for disaster prevention is described below as an example. The IoT device 400 is not limited to a specific kind of device, and scene data provided by the IoT network system 1 are not limited to a specific kind of data. In the following description of an operation example, it is assumed that the user makes a contract with a provider in advance, on the premise that the user receives a service by the IoT network system 1. A function unit that performs processing or a path where data are transmitted is described below by giving a number thereto.

FIG. 3 is a diagram illustrating an example of the operation of the IoT network infrastructure system 200 during normal time.

(1) During normal time, the device data acquisition unit 216 periodically acquires device data (position information, a band, a priority degree, and the like of the IoT device 400) from the core network 300 side.
(2) The device data acquisition unit 216 passes (outputs) the acquired device data to the device data fabrication unit 217.
(3) The device data fabrication unit 217 fabricates, as needed, the device data acquired by the device data acquisition unit 216 (e.g., masks information with which an individual is identifiable, for information on a third party). For example, the device data fabrication unit 217 refers to contract information managed by the contract information management unit 213, and fabricates the device data in accordance with a fabrication method determined in the contract information.
(4) The device data fabrication unit 217 passes the device data to the device data management unit 214.
(5) The device data management unit 214 stores the device data acquired by the device data acquisition unit 216 and fabricated, as needed, by the device data fabrication unit 217.
(6) A range of the IoT device 400 being acquirable by the terminal device 100 during normal time is predetermined by a contract between the user and the provider. For example, during normal time, the first IoT device 411 being the IoT device 400 of the same user as the terminal device 100 transmits image data to the terminal device 100.

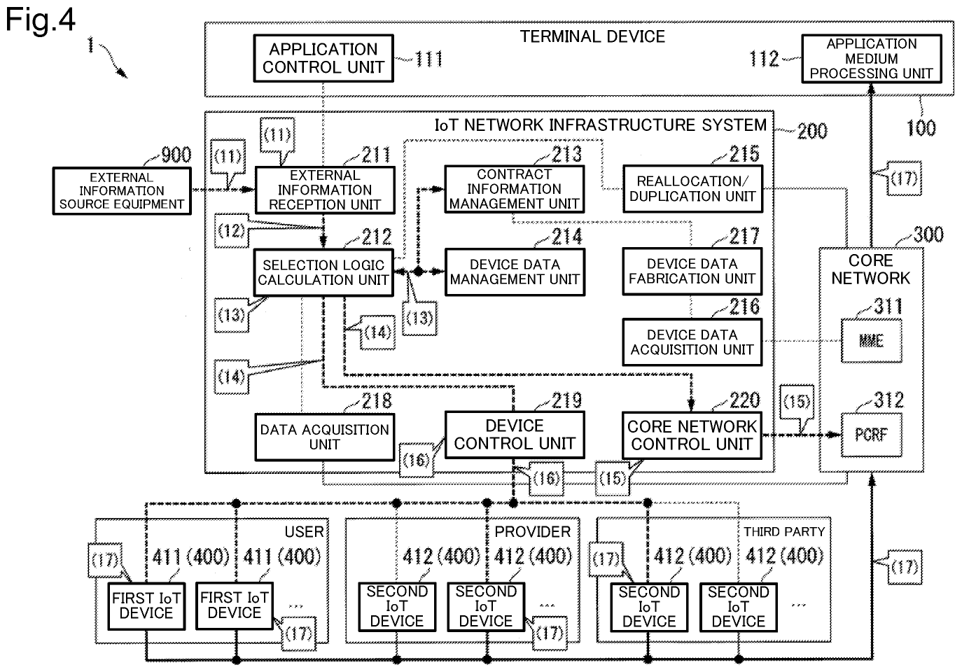

FIG. 4 is a diagram illustrating an example of a procedure of processing performed by the IoT network infrastructure system 200, based on external information, during time of emergency such as time of disaster (an earthquake or the like) occurrence.

(11) The external information reception unit 211 receives disaster information from the external information source equipment 900. For example, the IoT network infrastructure system 200 cooperates with an external institution such as the Meteorological Agency, and receives disaster information (e.g., position information, intensity of a disaster, and the like) from a server device of the external institution.
(12) The external information reception unit 211 passes the received information to the selection logic calculation unit 212.
(13) The selection logic calculation unit 212 selects an IoT device from the first IoT device 411 and the second IoT device 412, based on information being included in the external information and indicating a place in an emergent state, the contract information, and use status of the IoT device 400. Specifically, the selection logic calculation unit 212 checks the contract information by accessing the contract information management unit 213. The selection logic calculation unit 212 recognizes the use status of the IoT device 400 by accessing the device data management unit 214. Particularly, the selection logic calculation unit 212 recognizes whether another one of the terminal devices 100 (another application) is using the IoT device 400, based on the use status of the IoT device 400. The selection logic calculation unit 212 selects the IoT device 400 being within a scope of the contract and being usable (not used by the another application).
(14) The selection logic calculation unit 212 notifies the core network control unit 220 and the device control unit 219 of the selected IoT device 400.
(15) The core network control unit 220 instructs the core network 300 to perform priority control for a communication of the selected IoT device 400. For example, when prioritizing a communication of a camera being present in an area with a seismic intensity of 5 or more, the core network control unit 220 instructs the PCRF 312 of the core network 300 to widen a band of the camera and elevate a priority degree thereof. The core network control unit 220 instructs the core network 300 side to narrow bands of a camera in an area other than the former area and another one of the IoT devices 400 (a smart meter or the like), and lower priority degrees thereof. When the IoT device 400 transmits image data via a fixed network, the core network control unit 220 performs indication of the band, priority degree, and the like of a communication of the IoT device 400 to the fixed network.
(16) The device control unit 219 instructs the selected IoT device 400 to transmit image data.
(17) The selected IoT device 400 transmits image data to the terminal device 100 in accordance with control of the device control unit 219. In this instance, the core network 300 transmits the image data from the IoT device 400 to the terminal device 100, in accordance with the band and priority degree indicated by the core network control unit 220.

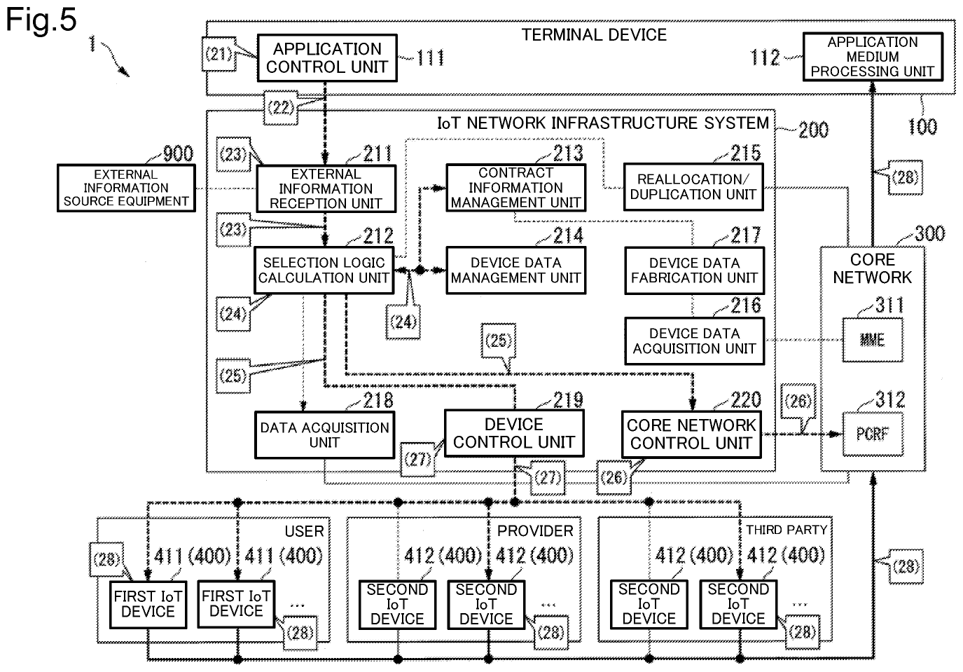

FIG. 5 is a diagram illustrating an example of processing performed by the IoT network infrastructure system 200, based on an instruction of the user (external information), during time of emergency such as time of disaster occurrence. The IoT network infrastructure system 200 switches from processing during normal time illustrated in FIG. 3 to processing in FIG. 5, based on the instruction of the user. Alternatively, the IoT network infrastructure system 200 may update selection of the IoT device 400 by performing the processing in FIG. 5, based on the user instruction, after performing the processing in FIG. 4.

(21) The user (e.g., a person in charge of disaster prevention of a local government or the like) designates an area being desired to be checked, for such a purpose as to check status of damage or ensure a flow line of a person having difficulty in going home. For example, the terminal device 100 displays a map on the display screen, and the manager performs designation of an area by performing a touch operation of encircling the area being desired to be check.
(22) The terminal device 100 transmits area designation information (information indicating the area designated by the user, i.e., external information) to the IoT network infrastructure system 200.
(23) In the IoT network infrastructure system 200, the external information reception unit 211 receives the area designation information, and passes the received area designation information to the selection logic calculation unit 212.
(24) The selection logic calculation unit 212 selects the IoT device 400, based on information indicating an area included in the area designation information, the contract information, and use status of the IoT device 400. As described with reference to FIG. 4, the selection logic calculation unit 212 checks the contract information by accessing the contract information management unit 213. The selection logic calculation unit 212 recognizes the use status of the IoT device 400 by accessing the device data management unit 214. Particularly, the selection logic calculation unit 212 recognizes whether another one of the terminal devices 100 (another application) is using the IoT device 400, based on the use status of the IoT device 400. The selection logic calculation unit 212 selects the IoT device 400 being within a scope of the contract and being usable (not used by the another application).
(25) The selection logic calculation unit 212 notifies the core network control unit 220 and the device control unit 219 of the selected IoT device 400.
(26) The core network control unit 220 instructs the core network 300 to perform priority control for a communication of the selected IoT device 400. When the IoT device 400 transmits image data via a fixed network, the core network control unit 220 performs indication of the band, priority degree, and the like of a communication of the IoT device 400 to the fixed network.
(27) The device control unit 219 instructs the selected IoT device 400 to transmit image data.
(28) The selected IoT device 400 transmits image data to the terminal device 100 in accordance with control of the device control unit 219. In this instance, the core network 300 transmits the image data from the IoT device 400 to the terminal device 100, in accordance with the band and priority degree indicated by the core network control unit 220.

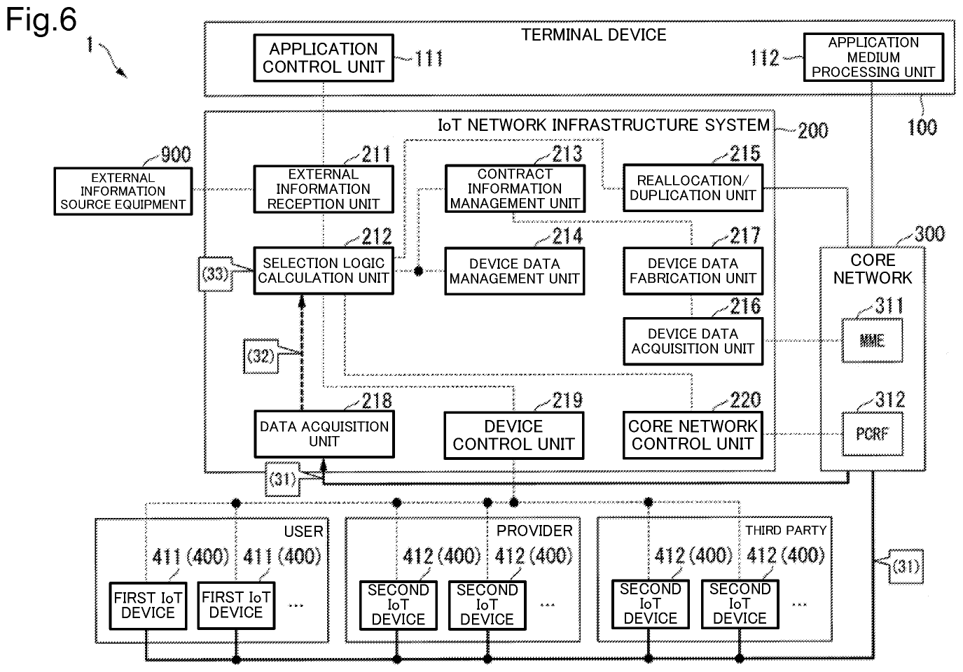

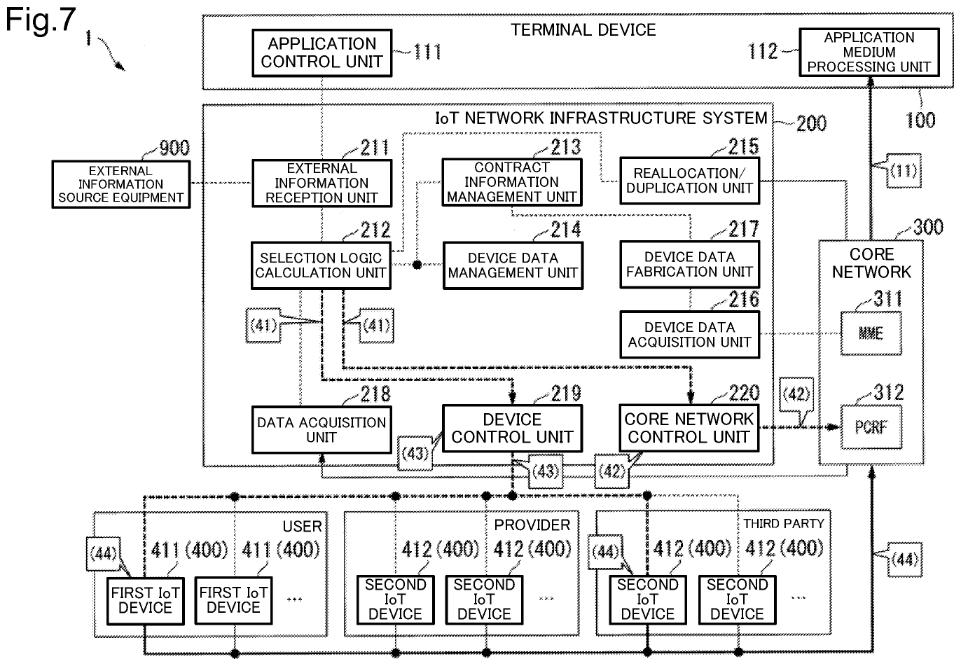

Herein, an operation example when the IoT network infrastructure system 200 selects the IoT device 400 by evaluating an image of the IoT device 400 is described with reference to FIGS. 6 and 7. Processing in FIGS. 6 and 7 applies to an option of processing performed by the selection logic calculation unit 212. The selection logic calculation unit 212 performs the processing in FIGS. 6 and 7 in the processing in (13) of FIG. 4.

FIG. 6 is a diagram illustrating an example of a processing procedure in which the IoT network infrastructure system 200 evaluates an image of the IoT device 400.

(31) The data acquisition unit 218 acquires image data from the IoT device 400 being a data request destination. For example, the data acquisition unit 218 acquires image data of all the IoT devices 400 located in an image acquisition target area such as a disaster area, among the IoT devices 400 (a fixed camera and an in-vehicle camera) being acquirable by the terminal device 100 in the contract between the user and the provider. When the IoT device 400 being a selection candidate does not transmit image data, the device control unit 219 may cause the IoT device 400 to transmit image data, by controlling the IoT device 400.
(32) The data acquisition unit 218 passes the acquired data to the selection logic calculation unit 212.
(33) The selection logic calculation unit 212 narrows down the IoT devices 400, based on the acquired data. For example, in a case of a disaster prevention solution, there is a possibility that the IoT device 400 is at fault during a disaster, or a possibility that a part or all of a field angle of a camera of the IoT device 400 is blocked by debris or the like, and thus, a desired image is not shown. Accordingly, the selection logic calculation unit 212 performs selection of the optimum IoT device 400 in an area requested from the terminal device 100, by narrowing down the IoT devices 400.

Specifically, the selection logic calculation unit 212 calculates how much the acquired image shows the area (what rate the number of effective pixels is at), and selects a camera showing the area the most. For example, when the whole image of a monitoring camera has P pixels, a part (effective part) showing the area in the whole image has p pixels, the selection logic calculation unit 212 selects, by priority, the IoT device 400 having the highest rate indicated by Expression (1).

$$\begin{matrix}[ Expression 1 ] & \\ \frac{p}{P} & ( 1 )\end{matrix}$$

FIG. 7 is a diagram illustrating an example of a processing procedure in which the IoT network infrastructure system 200 causes the selected IoT device 400 to transmit image data. The IoT network infrastructure system 200 performs the processing in FIG. 7 after the processing in FIG. 6.

(41) The selection logic calculation unit 212 notifies the core network control unit 220 and the device control unit 219 of the selected IoT device 400.
(42) The core network control unit 220 instructs the core network 300 side to prioritize a communication of the selected IoT device 400.
(43) The device control unit 219 instructs the selected IoT device 400 to transmit image data.
(44) The selected IoT device 400 transmits image data to the terminal device 100 in accordance with control of the device control unit 219. In this instance, the core network 300 transmits the image data from the IoT device 400 to the terminal device 100, in accordance with the band and priority degree indicated by the core network control unit 220. In this case, the core network 300 allocates a band to a communication from the selected IoT device 400 to the terminal device 100 by priority in accordance with an instruction of the IoT network infrastructure system 200, and performs data transmission by priority.

The device control unit 219 may enhance accuracy of data by controlling the IoT device 400. For example, when a part of the field angle of the camera of the IoT device 400 is covered by debris, the device control unit 219 may instruct the IoT device 400 to move a direction of the camera to a side opposite to the debris. Alternatively, the device control unit 219 may instruct the IoT device 400 to modify a zoom in addition to or instead of the direction of the camera. There is a possibility that a value of Expression (1) increases due to the modification in the direction of the camera or the modification in a zoom. After the device control unit 219 controls the IoT device 400, the selection logic calculation unit 212 may perform selection of the IoT device 400 by using the value of Expression (1) after the control.

Processing in which the selection logic calculation unit 212 calculates the rate indicated by Expression (1) applies to an example of processing of checking whether desired data can be acquired from the selected (primarily picked) IoT device 400. Processing in which the device control unit 219 changes one or both of the direction and a zoom of the camera of the IoT device 400 applies to an example of processing of controlling the selected IoT device 400 in order to check whether desired data can be acquired. Processing in which the selection logic calculation unit 212 selects another one of the IoT devices 400 of which the rate indicated by Expression (1) is higher than that of a certain IoT device 400 applies to an example of processing of selecting the another one of the IoT devices 400 when checking that it is not possible to acquire desired data.

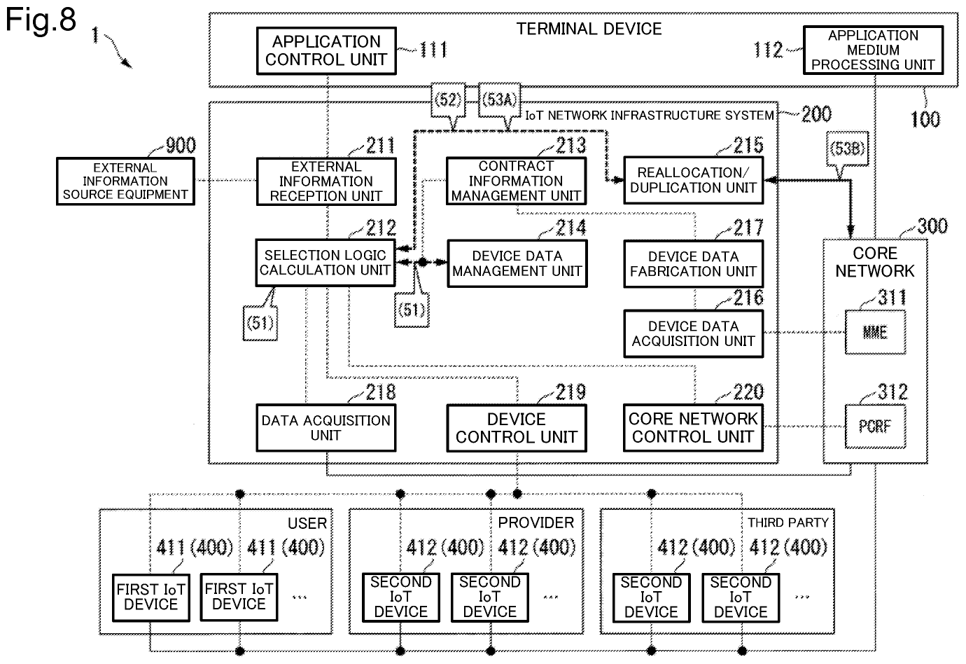

FIG. 8 is a diagram illustrating an example of a processing procedure of the IoT network infrastructure system 200 when a plurality of terminal devices 100 exist, and a data request to or control of the same IoT device 400 from the plurality of terminal devices 100 is needed. FIG. 8 illustrates an example of processing of the IoT network infrastructure system 200, for example, when a plurality of applications exist, and a data request to or control of the same IoT device 400 from an application other than a monitoring application is needed.

(51) When the IoT network infrastructure system 200 receives, from the terminal device 100, a transmission request for new image data, the selection logic calculation unit 212 selects the optimum IoT device 400. The device data management unit 214 is checked as to whether the IoT device 400 is controllable. A method by which the selection logic calculation unit 212 selects the IoT device 400 is similar to the method described with reference to FIGS. 4 to 6.
(52) When the same IoT device 400 is selected as a transmission source of image data with regard to the plurality of terminal devices 100, processing in this part is shifted from the selection logic calculation unit 212 to the reallocation/duplication unit 215.
(53A) When a data request to or control of the same IoT device 400 from the plurality of terminal devices 100 is needed, the reallocation/duplication unit 215 performs reallocation to the prioritized terminal device 100. The reallocation/duplication unit 215 recognizes information on a priority degree of each of the terminal devices 100 (e.g., a priority degree of each application), and passes a right of controlling the IoT device 400 to the prioritized terminal device 100 by checking priority degree information and the contract information. The reallocation/duplication unit 215 assigns the next optimum IoT device 400 to the terminal device 100 being deprived of the control right. The reallocation/duplication unit 215 notifies the selection logic calculation unit 212 of a result of the assignment of the IoT device 400 to the terminal device 100.
(53B) On the other hand, when the plurality of terminal devices 100 are able to share an image of the same IoT device 400, the reallocation/duplication unit 215 duplicates the acquired data, and then transmits duplicated data to the plurality of terminal devices 100 being request sources. The determination of whether the plurality of terminal devices 100 are able to share an image of the same IoT device 400 is made, for example, by the reallocation/duplication unit 215, based on a kind of application being executed by the terminal devices 100. Alternatively, the user may notify of whether the image is usable, with reference to a duplicated image.

Monitoring of a trouble in an event, and congestion monitoring are cited as application examples of the IoT network infrastructure system 200 other than the disaster prevention solution described above. For example, when an incident or an accident occurs in a marathon competition, it is important that a head office of the competition, the police, or the like can acquire an image of a scene. They acquire the image for a purpose such as recognition of occurrence status of the incident or damage status, ensuring of flow lines of a marathon participant (runner) and a spectator, and tracking of a criminal. In this instance, particularly in an event such as a marathon competition the site of which extends in a wide area, it is important to select the appropriate IoT device 400 according to a place where an incident or an accident occurs, and places where a marathon participant and a spectator stay.

Thus, the IoT network infrastructure system 200 selects the IoT device 400 for capturing an image of a scene (chooses a fixed network camera, an in-vehicle camera, or the like), and then causes the IoT device 400 to transmit an image. Alternatively, the IoT network infrastructure system 200 may cause the core network 300 to transmit the image by priority, by controlling the core network 300. For example, the IoT network infrastructure system 200 receives, from the terminal device 100, an input of a place where an incident or an accident occurs and damage status of a building, and selects the IoT device 400, based on the input.

When an incident or an accident occurs in a fireworks show, it is important that a head office of the show, the police, or the like can acquire an image of a scene. They acquire the image for a purpose such as recognition of occurrence status of the incident or damage status, ensuring of a flow line of a spectator, and tracking of a criminal. In this instance, in an event such as a fireworks show in which the number of spectators is large, it is considered that there are a variety of evacuation routes and evacuation destinations of the spectators. In this respect in particular, it is important to select the appropriate IoT device 400 according to a place where an incident or an accident occurs or places where a spectator stays.

Thus, the IoT network infrastructure system 200 may select the IoT device 400 for capturing an image of a scene (chooses a fixed network camera, an in-vehicle camera, or the like), then cause the IoT device 400 to transmit an image, and cause the core network 300 to transmit the image by priority, by controlling the core network 300. For example, the IoT network infrastructure system 200 receives, from the terminal device 100, an input of a place where an incident occurs and damage status, and selects the IoT device 400, based on the input. The IoT network infrastructure system 200 may be used in order to monitor in such a way that a spectator can safely and smoothly go home after end of an event such as a fireworks show in which the number of spectators is large.

For example, when congestion occurs on Golden Week, Obon, or the like, the IoT network infrastructure system 200 selects the IoT device 400 in a place where the congestion occurs. The IoT network infrastructure system 200 chooses a fixed network camera, an in-vehicle camera, or the like, and then causes the camera or the like to transmit an image. Alternatively, the IoT network infrastructure system 200 may cause the core network 300 to transmit the image by priority, by controlling the core network 300. For example, the IoT network infrastructure system 200 receives, from a server device for congestion monitoring, an input of a congestion information status, and performs selection of the IoT device 400, based on the input. The server device for congestion monitoring applies to an example of the external information source equipment 900. Consequently, a person in charge of congestion monitoring can acquire more credible road information from a camera image, and provide a driver with more accurate information for congestion avoidance.

As described above, the external information reception unit 211 receives external information. The selection logic calculation unit 212 selects, based on the received external information, the IoT device 400, from the first IoT device 411 and the second IoT device 412. The first IoT device 411 is a device that transmits data during normal time. The second IoT device 412 is a device different from the first IoT device 411. The device control unit 219 instructs the IoT device 400 selected by the selection logic calculation unit 212 to transmit data.

While instructing only the first IoT device 411 to transmit data during normal time, the IoT network infrastructure system 200 instructs an IoT device selected from the first IoT device 411 and the second IoT device 412 to transmit data during time of emergency. In other words, a target of an IoT device that the device control unit 219 instructs to transmit data is extended to the first IoT device 411 and the second IoT device 412 during time of emergency. Consequently, a possibility that desired data can be acquired from an IoT device can be raised during time of emergency.

For example, in a case where the IoT network infrastructure system 200 detects that it is time of emergency, such as a case where the IoT network infrastructure system 200 is notified of occurrence of a disaster by external information, the user becomes able to utilize scene data from the second IoT device 412. Thus, the IoT network infrastructure system 200 can enlarge an acquisition range of scene data during a disaster, without needing to additionally provide the IoT device 400 for disaster prevention.

For example, when the user does not have the suitable first IoT device 411 owned by the user in an area of interest, the user can also acquire scene data (e.g., image data) from the second IoT device 412 owned by a provider or a third party. The IoT network infrastructure system 200 can provide scene data being more suitable to a request of the user, by enlarging the IoT devices 400 that can acquire scene data.

When the first IoT devices 411 are increased in order to widen an acquisition range of scene data by an IoT device, there is a possibility that congestion of a network is caused. In contrast, according to the IoT network infrastructure system 200, a possibility that congestion of a network occurs is comparatively small in that the second IoT device 412 owned by a provider or a third party can be used, and additional provision of the first IoT devices 411 is not needed. The IoT network infrastructure system 200 can determine a priority degree of an IoT device to be selected, based on contract information and use status of each of the IoT devices 400. This enables priority control for data transmission of the selected IoT device, independently of congestion of a network.

For example, the selection logic calculation unit 212 may select the IoT device 400 being present in a place in an emergent state, based on information included in external information and indicating the place in an emergent state. Alternatively, the selection logic calculation unit 212 may select the IoT device 400 considered to be associated with a place in an emergent state.

The selection logic calculation unit 212 performs selection of the IoT device 400, based on information included in external information and indicating a place in an emergent state. Consequently, for example, for a user, such as a municipal staff member who takes a disaster measurement, needing data relating to an emergent state, the IoT network system 1 can raise a possibility that data desired by the user can be provided.

The selection logic calculation unit 212 further performs selection of the IoT device 400, based on contract information indicating whether each IoT device is usable. For example, in order that scene data are acquirable from not only the IoT device 400 (the first IoT device 411) owned by the user but also the IoT device 400 (the second IoT device 412) owned by a provider or a third party, a contract is made between the user and the provider (service provider) in advance. Contract information is managed in the contract information management unit 213 of the IoT network infrastructure system 200. The user can acquire scene data from the IoT device 400 (particularly, the second IoT device 412) within a scope of the contract.

The IoT network infrastructure system 200 is capable of an operation reflecting intentions of both the user (a user of scene data) and a scene data provider by determining the usable second IoT device 412 in the contract. A possibility of a trouble can be reduced by clarifying, in the contract, a framework of taking the IoT device 400 (the second IoT device 412) owned by the provider or the third party into a supply source of scene data. The second IoT device 412 may be configured by using an in-vehicle camera, may be configured by using a fixed camera, or may be configured by using a portable camera (e.g., a camera of a smartphone).

The selection logic calculation unit 212 further performs selection of an IoT device, based on use status of each IoT device. Consequently, the IoT network infrastructure system 200 can avoid occurrence of a conflict resulting from allocation of the same second IoT device 412 to the plurality of terminal devices 100. Alternatively, the IoT network infrastructure system 200 duplicates scene data of the second IoT device 412, and thereby, the plurality of terminal devices 100 can share the scene data of the second IoT device 412.

For example, it is assumed that there are requests for scene data of the same IoT device 400 from the plurality of terminal devices 100 (a plurality of applications). In this case, the IoT network infrastructure system 200 provides the requested scene data of the IoT device 400 to the request having a high priority degree (the terminal device 100 having a high priority degree). Alternatively, when the plurality of terminal devices 100 are able to share scene data, the IoT network infrastructure system 200 duplicates the requested scene data of the IoT device 400, and provides duplicated data to each of the terminal devices 100.

The selection logic calculation unit 212 checks whether desired data can be acquired from the selected IoT device. Consequently, the IoT network infrastructure system 200 raises a possibility that desired data can be provided to the user. The desired data referred to herein are scene data determined to be appropriate based on a determination criterion of appropriateness of scene data as in Expression (1) described above. For example, the IoT network infrastructure system 200 can provide a more appropriate image to the terminal device 100 in such a way as to avoid an image in which view is obstructed by debris.

The device control unit 219 controls the selected IoT device 400 in order to check whether desired data can be acquired. For example, suppose a case where the IoT device 400 is equipped with a camera, and transmits captured image data. Herein, when a state of an image is not good in image data acquired by the data acquisition unit 218, the device control unit 219 modifies a direction (direction of capturing) of the IoT device 400 or a zoom by controlling the IoT device 400. Thus, the device control unit 219 controls the selected IoT device 400, and thereby, a possibility that desired data can be provided to the user is raised.

When determining by the check that it is not possible to acquire desired data, the selection logic calculation unit 212 selects another one of the IoT devices 400. Consequently, the IoT network infrastructure system 200 raises a possibility that desired data can be provided to the user.

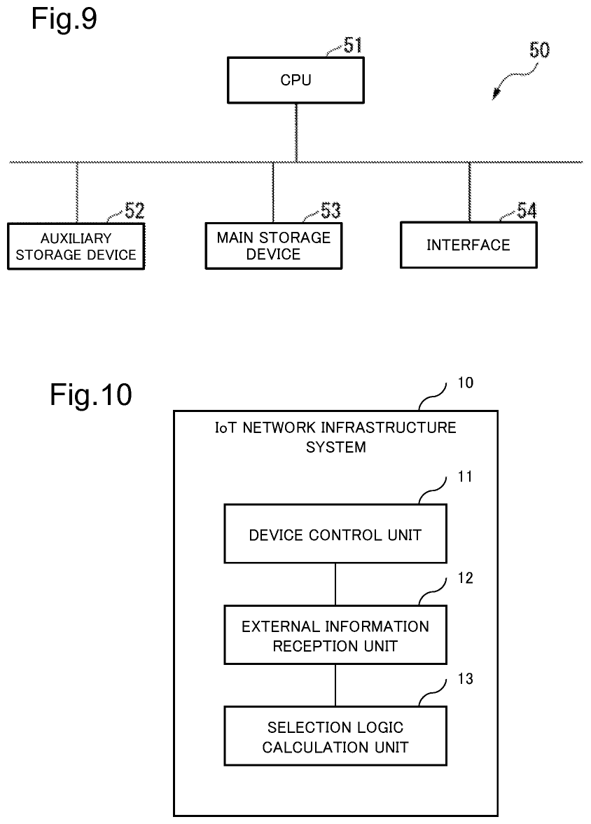

FIG. 9 is a schematic block diagram illustrating a configuration of a computer according to at least one example embodiment. A computer 50 illustrated in FIG. 9 includes a CPU 51, a main storage device 53, an auxiliary storage device 52, and an interface 54. The IoT network infrastructure system 200 described above is mounted in the computer 50. An operation of each unit of the IoT network infrastructure system 200 is stored in the auxiliary storage device 52 in a format of a program. The CPU 51 extracts the program in the main storage device 53 by reading the program from the auxiliary storage device 52, and executes the processing described above in accordance with the program.

Next, a minimum configuration according to the present example embodiment is described with reference to FIG. 10. FIG. 10 is a diagram illustrating an example of a minimum configuration of an IoT network infrastructure system. An IoT network infrastructure system 10 illustrated in FIG. 10 includes an external information reception unit 12, a selection logic calculation unit 13, and a device control unit 11.

In such a configuration, the external information reception unit 12 receives external information. The selection logic calculation unit 13 selects, based on the received external information, an IoT device from a first IoT device that transmits data during normal time and a second IoT device different from the first IoT device. The device control unit 11 instructs the selected IoT device to transmit data.

While instructing only the first IoT device to transmit data during normal time, the IoT network infrastructure system 10 instructs an IoT device selected from the first IoT device and the second IoT device to transmit data during time of emergency. In other words, a target of an IoT device that the device control unit 11 instructs to transmit data is extended to the first IoT device and the second IoT device during time of emergency. Consequently, a possibility that desired data can be acquired from an IoT device can be raised during time of emergency.

Processing of each unit may be performed by recording, in a computer-readable recording medium, a program for achieving the entire or a part of processing performed by the IoT network infrastructure system 200, and then reading and executing, in a computer system, the program recorded in recording medium. It is assumed that the “computer system” referred to herein includes hardware such as an OS or peripheral equipment. The “computer-readable recording medium” refers to a portable medium such as a flexible disk, a magnet-optical disk, a ROM, or a CD-ROM, or a storage device such as hard disk incorporated in a computer system. The program described above may serve to achieve some of the functions described above, and the function described above may be achieved by a combination with a program already recorded in the computer system.

While the example embodiment of this invention has been described above in detail with reference to the drawings, a specific configuration is not limited to the example embodiment, and a design or the like in a scope that does not depart from the spirit of this invention also falls within this invention.

The invention has been particularly shown and described with reference to example embodiments as typical examples thereof. However, the invention is not limited to these embodiments. In other words, it will be understood by those of ordinary skill in the art that various changes in form and details may be made therein without departing from the spirit and scope of the present invention as defined by the claims.

This application is based upon and claims the benefit of priority from Japanese Patent Application No. 2017-254619, filed on Dec. 28, 2017, the disclosure of which is incorporated herein in its entirety by reference.

### REFERENCE SIGNS LIST

1 IoT network system
10, 200 IoT network infrastructure system
11, 219 Device control unit
12, 211 External information reception unit
13, 212 Selection logic calculation unit
100 Terminal device
111 Application control unit
112 Application medium processing unit
213 Contract information management unit
214 Device data management unit
215 Reallocation/duplication unit
216 Device data acquisition unit
217 Device data fabrication unit
218 Data acquisition unit
220 Core network control unit
300 Core network
311 MME
312 PCRF
400 IoT device
411 First IoT device
412 Second IoT device

What is claimed is:

1. An IoT device control method comprising:
receiving external information;
selecting, based on the received external information, an IoT device among a first IoT device which transmits a data during normal time and a second IoT device different from the first IoT device; and
instructing the selected IoT device to transmit data.

2. The IoT device control method according to claim 1,
wherein the selection of the IoT device is based on information being included in the external information and indicating a place in an emergent state.

3. The IoT device control method according to claim 2,
wherein the selection of the IoT device is further based on contract information indicating whether each IoT device is usable.

4. The IoT device control method according to claim 3,
wherein the selection of the IoT device is further based on use status of each of the IoT devices.

5. The IoT device control method according to claim 4, further comprising;
checking whether desired data can be acquired from the selected IoT device.

6. The IoT device control method according to claim 5, further comprising;
controlling the selected IoT device in order to check whether the desired data can be acquired.

7. The IoT device control method according to claim 5, further comprising;
selecting another IoT device when checking that acquisition of the desired data is not possible.

8. The IoT device control method according to claim 1, further comprising;
selecting an IoT device being present in a place in an emergent state, based on information being included in the external information and indicating a place in an emergent state.

9. A recording medium recording a program that causes a computer to execute:
processing of receiving external information;
processing of selecting, based on the received external information, an IoT device among a first IoT device that transmits data during normal time and a second IoT device different from the first IoT device; and
processing of instructing the selected IoT device to transmit data.

10. An IoT network infrastructure system that controls an IoT device, comprising:
an external information receiver receiving external information;
a selection logic calculator selecting, based on the received external information, an IoT device from a first IoT device that transmits data during normal time and a second IoT device different from the first IoT device; and
a device controller instructing the selected IoT device to transmit data.

11. The IoT device control method according to claim 2, further comprising;
selecting an IoT device being present in a place in an emergent state, based on information being included in the external information and indicating a place in an emergent state.

12. The IoT device control method according to claim 3, further comprising;
selecting an IoT device being present in a place in an emergent state, based on information being included in the external information and indicating a place in an emergent state.

13. The IoT device control method according to claim 4, further comprising;
selecting an IoT device being present in a place in an emergent state, based on information being included in the external information and indicating a place in an emergent state.

14. The IoT device control method according to claim 5, further comprising;
selecting an IoT device being present in a place in an emergent state, based on information being included in the external information and indicating a place in an emergent state.

15. The IoT device control method according to claim 6, further comprising;
selecting an IoT device being present in a place in an emergent state, based on information being included in the external information and indicating a place in an emergent state.

16. The IoT device control method according to claim 7, further comprising; selecting an IoT device being present in a place in an emergent state, based on information being included in the external information and indicating a place in an emergent state.

17. The IoT device control method according to claim 6, further comprising;
selecting another IoT device when checking that acquisition of the desired data is not possible.
